(19) United States
(12) Patent Application Publication
(10) Pub. No.: US 2008/0154642 A1
(43) Pub. Date: Jun. 26, 2008

(54) Healthcare Core Measure Tracking Software and Database

(76) Inventors: Susan Marble, Natick, MA (US); Sandra Sieck, Mobile, AL (US); Joseph F. Foster, Mobile, AL (US); James Hoekstra, Lewisville, NC (US); Yvette DeLaune Stancil, Wake Forest, NC (US); Patsy Fowlkes, Amory, MS (US); Stephen Brandon, Amory, MS (US); Lois Gibson, Bradley Beach, NJ (US); Lisa Tripodi, Chicago, IL (US); David Larson, Burnsville, MN (US); R. Norman McDonald, Hickory, NC (US); Timothy Henry, Minneapolis, MN (US); Michael J. Rizzo, Reading, MA (US)

Correspondence Address: JOHATHAN P. O''BRIEN;MILLER, CANFIELD, PADDOCK AND STONE, P.L.C., 277 SOUTH ROSE STREET, SUITE 5000, KALAMAZOO, MI, 49007, US

(21) Appl. No.: 11/614,524

(22) Filed: Dec. 21, 2006

(51) Int. Cl. G06Q 50/00

(52) U.S. Cl. 705/3

(57) ABSTRACT

Software and a system created by the software with its application are applied in the healthcare setting for various patients corresponding to the CMS or JCAHO core measures. The software and its system captures necessary patient data related to future P4P initiatives designed by federal authorities, private payors or other organizations plus report safety events. The software allows real-time data entry at the bedside, during patient care processes, from admission to discharge. The system provides real-time feedback to practitioners on their performance as well as hospital benchmarking. The software can be used on a variety of hardware devices, and may gather data from various hospital information systems.

### BACKGROUND OF THE INVENTION

1. Field of the Invention

The present invention is directed generally to healthcare core measure tracking software and database patent filing, and more specifically to a computer software program to gather, collate and report hospital core measures performance for federal quality assurance programs.

2. Description of the Related Art

The Center for Medicare and Medicaid Services (CMS) and the Joint Commission for the Accreditation of Hospitals (JCAHO) have initiated a federally-mandated system for assessing quality of care in U.S. Hospitals. This system tracks hospital performance on patient care in specific disease states like myocardial infarction (heart attack), congestive heart failure, pneumonia, pregnancy, venous thromboembolism and specific surgical procedures. Hospital performance is monitored by the mandatory quarterly reporting of certain “core measures” for each disease state to CMS or JCAHO. CMS and JCAHO then summarize the hospital performance on each core measure, and rate the hospital on its overall performance for each disease state. These hospital ratings are in the public domain, and are thus of significant concern to hospital administrators and healthcare providers. In the near future, CMS intends to link hospital performance on core measures to patient care reimbursements by Medicare or Medicaid. These so-called “pay for performance” programs allow CMS to increase their reimbursement rates to high-performing hospitals. Accuracy and timeliness of this core measures data collection is crucial for hospital administrators and care givers alike.

Hospitals in the U.S. are federally-mandated to report their performance on certain quality core measures. These core measures include both process measures and outcomes for patients hospitalized with specific disease states. Core measures are reported to federal agencies, who then track hospital performance and display the results in the public domain. In the near future, a given hospital's performance will be directly linked to federally-sponsored reimbursement augmentation programs, so called “pay for performance” programs.

At present, these core measures are gathered retrospectively, by painstaking manual medical chart review, and entered into federally-mandated databases by manual data entry or through third-party vendors. Federally-reported data lags as much as a year behind actual patient care, making quality assurance feedback and performance modification for physicians, hospitals, and healthcare providers difficult.

For example, there are some 1.8 million visits annually for acute coronary syndrome (ACS). About 10% of the population accounts for up to half of the healthcare expenditures of which ACS is a leading contributor. In the U.S., statistics indicate that physicians will prescribe the correct medicine only 60% of the time. It is estimated that as much as $78 billion or 5% of the U.S. healthcare budget is due to medical errors.

While physicians could go to a computer and try to pull up the guidelines, they generally don't do so. What is needed is software which automatically gives them the preferred treatment option for the circumstances presented, i.e., the patient's condition and the time elapsed since occurrence of certain events in the episode. Presumably, using the preferred treatment will produce a better outcome for the patient, avoid medical errors and shorten the length of hospital stays. Also, with the institution of pay for performance (P4P) programs, Medicare will provide a 1-2 percent higher reimbursement when the preferred treatment is used.

### BRIEF SUMMARY OF THE INVENTION

This invention relates to software and a system created by the software together with its application in the healthcare setting for various patients and its connection to the CMS or JCAHO guidelines. The system provides a web-based platform for the direct entry of core measures data, at multiple points in the patient care process, from admission to discharge. The system provides real-time performance feedback to the practitioner. The software can be developed for use on a variety of hardware devices, and may be integrated to gather data directly from various hospital information systems. The software is adaptable as guidelines, core measures, and pay for performance initiatives change.

These and other features and advantages are evident from the following description of the present invention, with reference to the accompanying drawings.

### BRIEF DESCRIPTION OF THE SEVERAL VIEWS OF THE DRAWINGS

FIG. 1 is a diagram showing an example of a P4P software environment which may be used in connection with in one embodiment of the invention.

FIG. 2 depicts a flow of information in one embodiment of the invention.

FIG. 3 depicts a state transition diagram with finite states and transitions.

FIG. 4 is a diagram showing the work flow of the AMI core measure.

FIG. 5 is a diagram showing the work flow of the HF core measure.

FIG. 6 is a diagram showing the work flow of the pneumonia core measure.

FIG. 7 is a diagram showing the work flow of the H&K core measure.

FIG. 8 is a diagram showing the work flow of the SCIP core measure.

FIG. 9 is a diagram showing the work flow of the Pregnancy (PR) core measure

FIG. 10 is a diagram showing the work flow of the CABG core measure

FIG. 11 is a diagram showing the work flow of the VTE core measure.

FIG. 12 shows a login screen mockup.

FIG. 13 shows a lookup screen mockup.

FIG. 14 shows a selection screen mockup.

FIG. 15 shows a pathway (Core Measure) selection screen mockup.

FIG. 16 shows a coded screen AMI-1 mockup, “was aspirin administered?”

FIG. 17 shows a coded screen AMI-1.1 mockup, “Aspirin Exclusion”.

### DETAILED DESCRIPTION OF THE ILLUSTRATED EMBODIMENT

The invention relates to a computer software program which allows electronic, interactive, real-time core measures data entry at the patient bedside in addition to the option of entering the data retrospectively. The program allows a given hospital's core measure data to be collated electronically, allowing immediate feedback of performance to healthcare providers and the generation of reports of overall hospital performance including local and/or national benchmarking (database and data analysis component). The program also allows the electronically-stored core measures data to be transferred directly to federal databases for inclusion in their tracking reports of hospital performance (data submission component).

One embodiment of the invention stores this data, collates it by disease state, patient, and hospital, and generates reports for individual patients, hospitals, or care providers. There is the option for these reports to be generated in “real time” so that the care provider is provided with immediate feedback regarding compliance with quality core measures. In so far as feedback can be provided immediately, the healthcare provider can take real time corrective action at the patient's bedside to assure compliance. This embodiment also allows the transfer of this data electronically to federal databases for inclusion in federally-mandated hospital performance reports. This embodiment also allows for comparison of a given hospital's performance to hospitals of like size, by academic vs. community hospital designation, by for-profit vs. non-profit status, by bed number, by trauma center status, by payer mix, by patient co-morbidity, by admission volume, and/or by geography. Feedback can be provided to the hospital regarding its performance, with the identity of comparator hospitals being made anonymous.

The invention contributes essential “real time” healthcare IT solution strategies geared to bridging the worlds of hospital clinical care, regulatory healthcare performance initiatives, evidence based guidelines, and the medical industry together, thereby accelerating quality driven care and improving patient outcomes. This is useful to care providers, such as percutaneous coronary intervention (PCI) Hospitals and integrated health networks (IHNs), to other payors, such as BCBS, and to others, such as pharmaceutical/medical companies with products mentioned in disease-specific care guidelines. Guideline adherence is associated with improved clinical outcomes. Also, periodic feedback regarding guideline compliance from large registries yields improvements in metrics; however, these improvements in metrics tend to occur slowly.

For example, medication errors harm 1.5 million people a year in the U.S., kill several thousand and cost the nation's healthcare system at least $3.5 billion, says a new report from the Institute of Medicine. They're so common that patients should expect to experience an average of one for each day they're in the hospital, although most don't cause harm, the report said. While information technology can play a key role in correcting the problems on the providers' side, with computer systems that check for toxic interactions and bar coding to identify the correct patient and the correct medication, drug companies and patients also have responsibilities. The report called on drug companies to put a lid on free drug samples to doctors, which are poorly controlled, and to disclose the results of all clinical trials involving their drugs. Patients should keep lists of all their medications and bring them to every doctor's appointment or hospital admission. IT solutions which provide real-time feedback on guidelines-based care can improve utilization of appropriate therapies and decrease medical errors.

The role of registries and core measures data reporting is to capture modern data on patient outcomes treated according to guideline recommendations within the hospital setting outside of clinical trials. As guideline recommendations are created from clinical trial data, registries allow medical providers to ascertain and validate whether the guideline treatments improve outcomes and safety as documented in clinical trials or need modifications.

P4P incentive programs are designed to align financial reward with core measure adherence focused upon guideline recommendations to overcome the limitations of current reimbursement arrangements. The P4P initiative is being driven by quality improvement efforts that are grounded in evidence based/guideline based care. The early catalyst in P4P was the landmark report by the Institute of Medicine (IOM) in March 2001, Crossing the Quality Chasm, in which the IOM strongly recommended the federal government identify, test and evaluate payment options closely aligned to quality improvement goals thereby resulting in the 3 Year CMS/Premier P4P National Initiative, now named the Hospital Quality Incentive Demonstration Project (HQID), which began October 2003 and now has 277 participating hospitals. Currently 35 health plans offer P4P incentives nationally.

The invention seeks to augment educational efforts with Pay For Performance (P4P), provide immediate feedback to modify behavior, improve compliance, and improve outcomes.

To this end, the embodiment of the invention described herein comprises an electronic platform to collect clinical information and enhance patient records which may certify hospitals for additional 1-2% payments from CMS-centers for medicaid,/medicare services (hospital profit margins are 0-5% per American Hospital Association), improve guideline compliance via early/immediate feedback, provide local and national benchmarking and reduce medical errors.

### EXAMPLE

85% of the 5 million hospital admissions for chest pain are unnecessary and 5% of the 3 million discharges are missed Myocardial Infarctions (MIs).

All hospitals must track core measures, such as MI, Heart failure (HF), Pneumonia. Other diagnoses and measures may be added later. Performance on core measures is currently required to be reported quarterly, by diagnosis, and is made available to the public.

All measurement is retrospective, based on manual reviews, by nurses, quality coordinators. However, currently it is expensive to track core measures.

Other Problems may include: 1) ICD 9 codes don't match diagnoses; 2) paper systems lose outcomes; 3) outcomes are not linked to service; 4) the physician involved, the timing of intervention are difficult to piece together in retrospect; 5) prehospital or home treatment are not well documented; and 6) most importantly, performance feedback is not provided in real-time

One solution to this problem is to track electronically the use of medications, timing of medications, timing of interventions and discharge medications. A given patient's diagnosis is triggered by laboratory studies, LVEF, order sets, working diagnosis, chief complaint, Xray results (not retrospective ICD 9). The system matches performance to diagnosis, with continuous real-time feedback of performance.

### EXAMPLE

A patient presents to a hospital emergency department with chest pain or other symptoms of acute coronary syndrome (ACS) and is identified as an acute care patient. A nurse obtains standard demographic facts, medical history and current medication use information and enters this into a computing device equipped with the disclosed software system. An electrocardiogram (EKG) is obtained and provided to the emergency room physician. When the practitioner renders the initial diagnosis the computing device prompts the practitioner with a list of treatments universally recommended by the American College of Cardiology/American Heart Association recommended treatment guidelines for patients with ACS. As the practitioner administers care, data regarding the delivery of care and the timing of delivered care (primarily the delivery of medication) is entered into the device. Thus the practitioner is prompted to deliver guidelines based care and the device memorializes the timing of care since so many guidelines based therapies require timely administration. If a practitioner elects to not administer a therapy, the reasons for not administering the therapy are recorded so that the practitioner is not penalized for not treating the patient with a therapy that is contraindicated or potentially harmful given the patients other conditions. Performance is tracked by practitioner. The software also compares the course of treatment to local and national treatment guidelines and provides the practitioner with comparative information. The information is then transferred to a database which allows the hospital to submit data for P4P reimbursement. Treatment information and comparative data are available for placement in the patient's medical record. In addition to resulting in improved patient care by providing information that encourages practitioners to follow established treatment norms, the software also records adherence to the treatment standards to enable providers to obtain the enhanced reimbursements that are available to providers under the Centers for Medicare and Medicaid Services Pay-for-Performance (CMS/P4P) program.

One embodiment of the invention provides a software based system that allows for the data capture of key measures to store, compare and report quality core measures. The software program is a flexible application that allows for the capturing of medical quality (core) measures. The software may provide instant, real time feedback on medical decisions, compliance with guidelines, may reduce medication errors and may ensure the hospital will maximize reimbursement. In addition, the software will capture CMS/P4P performance measures, offer flexibility for continual updates, offset medical errors, report A/ES: INDUSTRY/FDA plus sentinel events and reinforce guideline recommendations.

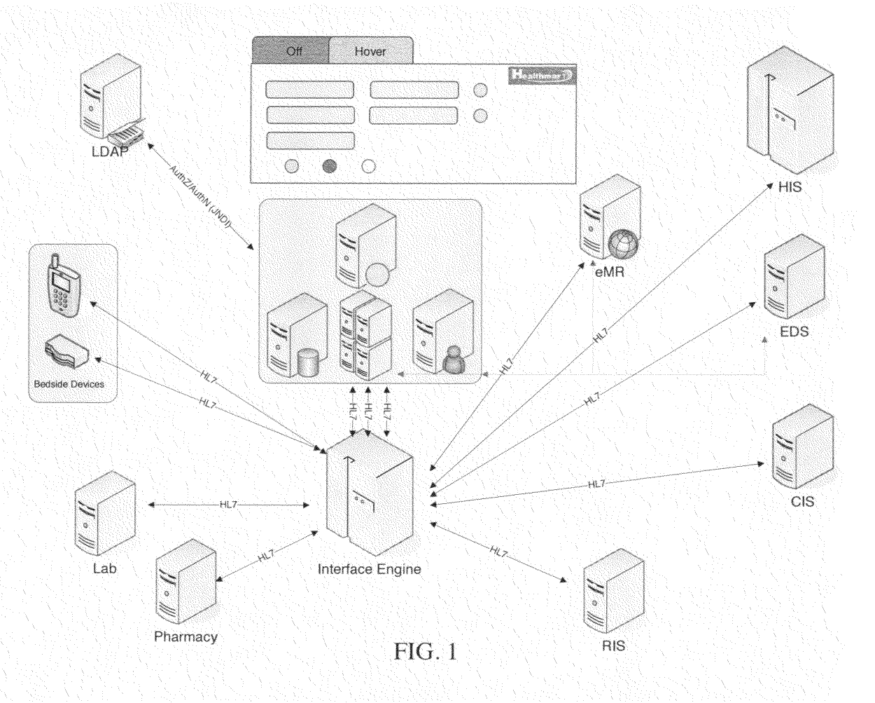

The software system may be supported on general computing hardware and may comprise: an input device, a display device, a core workflow manager, a flexible view controller, a HL7 messaging processor, a configurable report generator, an external interface for electronic transmission and an electronic database to compare performance at different sites. FIG. 1 is a diagram showing an example of a P4P software environment which may be used in connection with one embodiment of the invention.

Core functionality of filing core measures for patients may comprise the following steps:
a) Searching for, identifying a patient of record via any combination of: unique medical record number (mrn), name, patient encounter identifier, digital identifier or demographic data items such as date of birth or gender.
b) Selection of disease pathway: Acute Myocardial Infarction (AMI), Heart Failure (HF), Community Acquired Pneumonia (CAP), Surgical Care Improvement Project (SCIP), Hip & Knee Replacement (H&K), Pregnancy (PR), Coronary Artery Bypass Graft (CABG), Venous Thromboembolism (VTE).
c) Entry of coded key data points for selected pathway. Questions and answers are context sensitive and presented according to the configured flows within a workflow manager. Coded data points are summarized in diagrams A-H.
d) Edits and error correction of previously entered data items.
e) Indication of record completion and release of patient record.

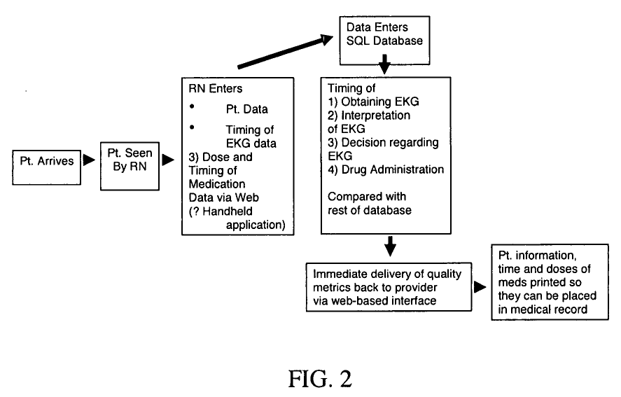

### FIG. 2 depicts a flow of information in one embodiment of the invention.

The core functionality of core measure data capture may be facilitated by a HL7 (Health Level 7) messaging component (e.g., HL7 message subscriber and relay station). The messaging component may allow for processing of standard HL7 messages for facilitation of core measure data reporting. HL7 messages may be supported by interface components:
ADT (Admission, discharge, transfer) Messages:
A01—Admit a patient
A04—Register a patient
A08—Update patient information
A11—Cancel an admit
A18—Merge patient information
MDM (Medical Document Management) Messages
ORU (Observation) Messages
RO1—Unsolicited

### As other universal standards evolve beyond HL7, the software would be adapted.

A highly configurable core workflow manager may assure compliance with all core measures, which can be determined through a set of predetermined question sets. A “question set” is a series of questions posed to the healthcare provider by the input device. These question sets have been determined by authoritative bodies based on medical findings and clinical evidence. These question sets may change over time as medicine and healthcare evolve and as the clinical evidence changes. The application can be modified via configuration changes and without any changes in source code to represent the changes in question sets. The application is modeled on principles of declarative programming.

A component of the workflow manager is a workflow engine. The workflow engine is a configurable state transition machine. The finite state transition machine (FSM) is a classic computer programming pattern. It allows for the modeling of a finite set of states within a system. Between each state 0 to M transitions may be present to allow for the navigation of a system. The idea is that there can be multiple variant paths to get from one end of a system to the other end. All these possible paths however can be broken down and modeled as finite States and Transitions. From a particular point in the system there are only a finite number of links that can be followed to arrive at another state. These links are so termed transitions. Every point along the path can be modeled as a State with various attributes to indicate the position within the nexus. Each State can be thought of as a decision point.

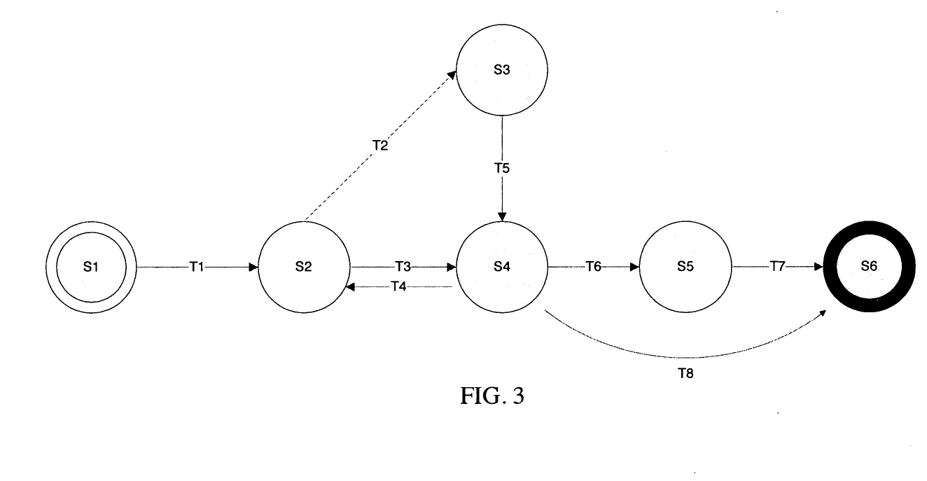

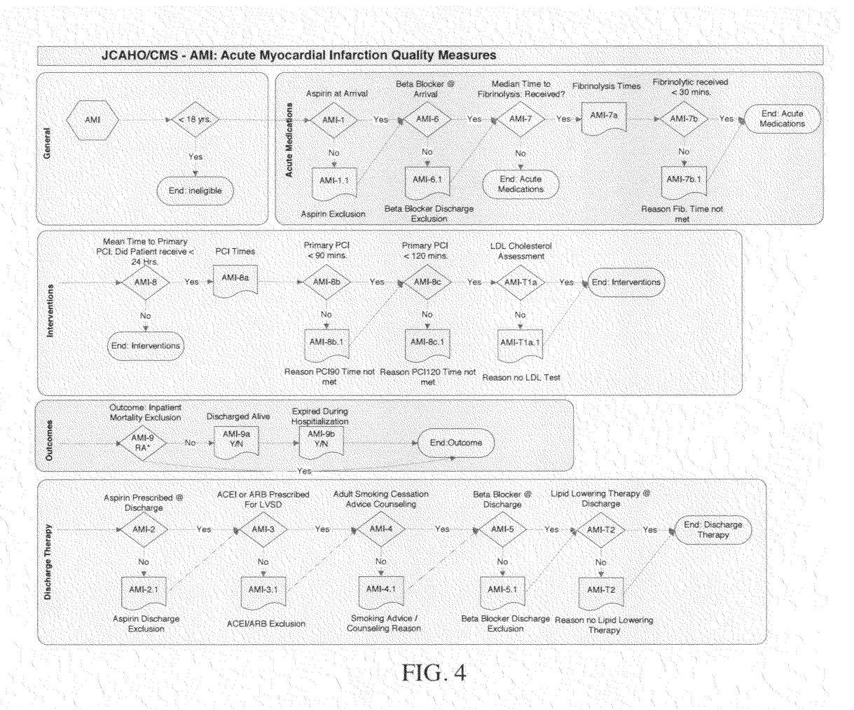

Within the context of the application; information is supplied to a WorkFlowManager by a ViewController, a decision is made, and a link is followed (a transition is made) to arrive at another State (decision point). The diagram of FIG. 3 depicts a State Transition diagram with finite states and transitions. An example flow through the system could be S1, T1 to S2, T2 to S3, T5 to S4, T8 to S6. Each work flow displayed in the diagrams of FIGS. 4-11 get modeled as State Transition diagrams.

The software may be termed a flexible decoupled application with clear separation layers of model and view. The application may primarily be developed as a web-based application and targeted for general PC hardware, but the application may be supported on other deployment targets, such as handheld devices, tablet PCs and thick client deployment. As indicated above, FIG. 1 is a diagram showing an example of a P4P software environment which may be used in connection with one embodiment of the invention.

The system contains a hybrid relational, xml, object database model that models the data repository for the core measures as well as accompanying tables for patient identifiers, including aliases; patient demographics; patient ADT information (registrations, admissions, discharges; patient encounters, and account tables). An authentication module supports integration with enterprise user repositories. Integration can be accomplished using the Lightweight Data Access Protocol (LDAP).

A standardized transaction syntax allows for propagation of core measure data to a centralized data warehouse. The data repository supports aggregation of core measure data and allows for census and geographical based reporting as well as exploratory data mining. Utilizing this database function, a given hospital's performance can be compared to hospitals of like size, by academic vs. commnunity hospital designation, by for-profit vs. non-profit status, by bed number, by trauma center status, by payer mix, by patient co-morbidity, by admission volume, and/or by geography. Feedback can be provided to the hospital regarding its performance, with the identity of comparator hospitals being made anonymous. All data may be stripped of Private Health Information (PHI) information when the transaction message is created, Electronic approvals are required before data is transmitted.

The system may include alternative patient identification mediums and implement integration components compatible with existing identification technologies including, for example radiofrequency ID (RFID), bar code scanning and proximity card readers.

A configurable report model may generate standard output formats including text-delimited, pdf and html. The report module includes canned reports that can be used by the healthcare organization to report by patients, by patient panels, by diagnosis, by core measure, or by hospital, by diagnosis CPT codes.

A transmission module may support electronic transmission of federally mandated filings to CMS and JCAHO authoritative bodies.

A database repository of collected information may be configured to drive data mining, predictive analysis and regional/national benchmarking.

### Quality Core Measure Data Diagrams

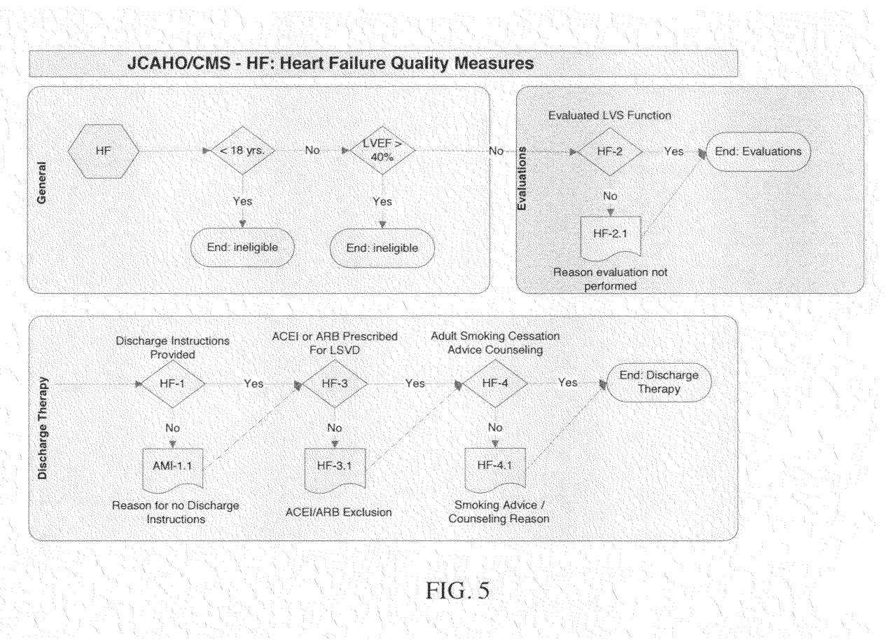

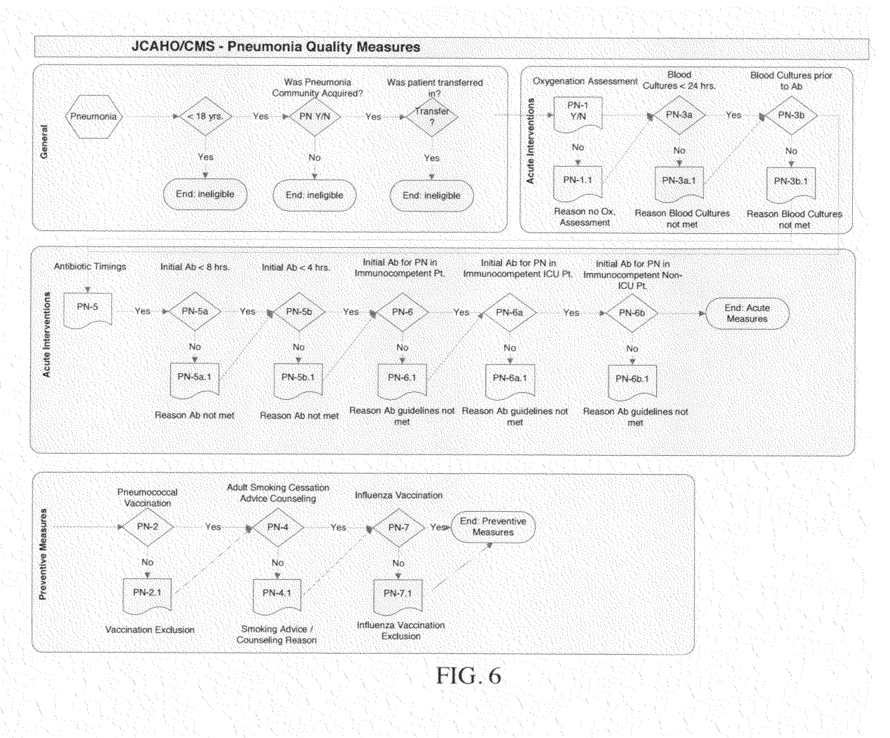

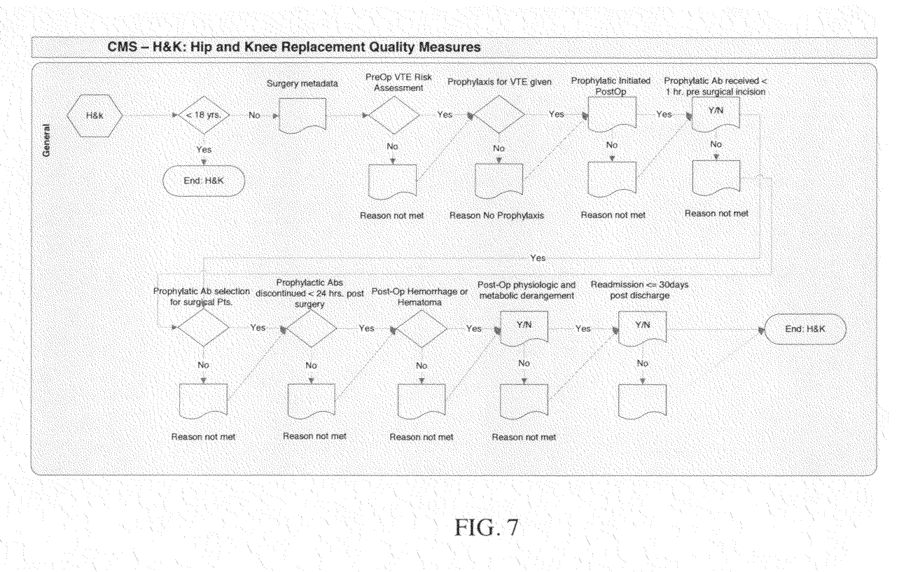

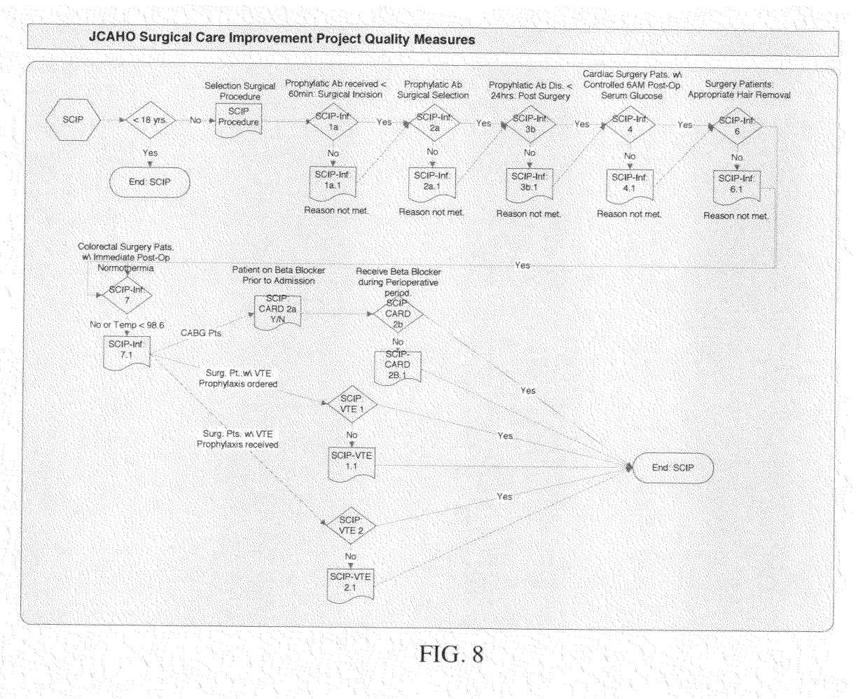

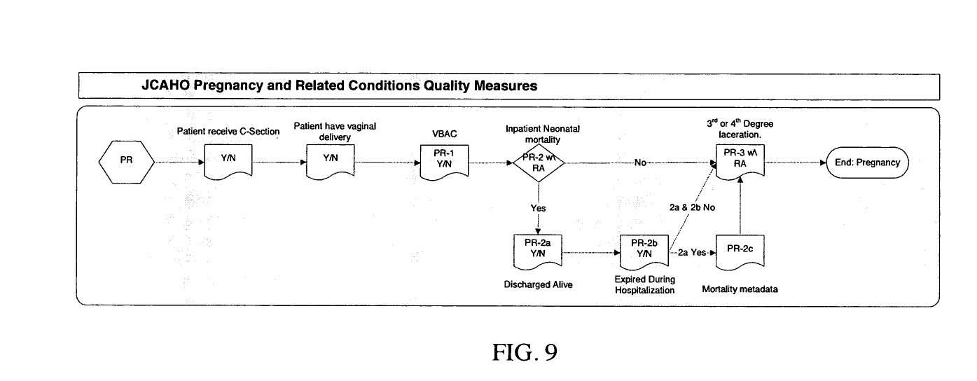

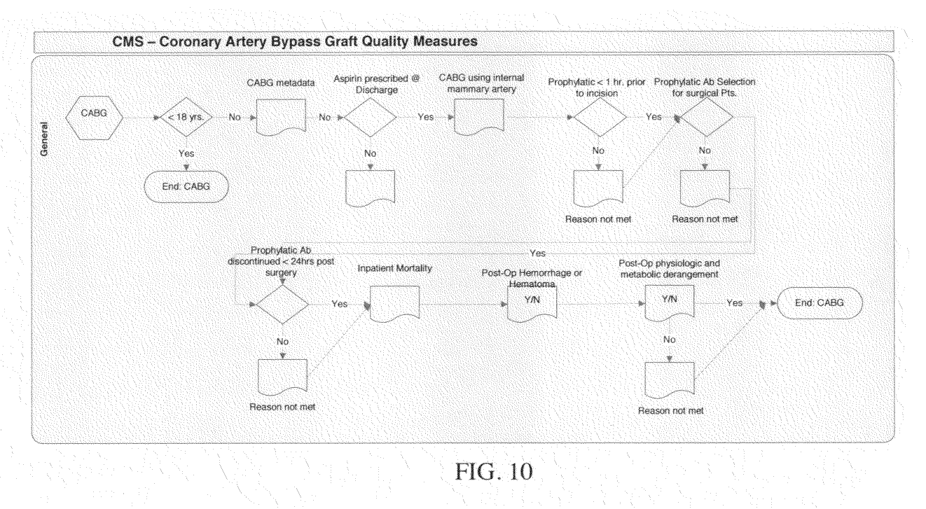

The following diagrams in FIGS. 4-11 depict the data flows for the disease pathways modeled within the core measures established by Joint Commission for the Accreditation of Hospitals (JCAHO) and The Center for Medicare and Medicaid Services (CMS). The pathways include the coded data points as mentioned in “Claims” section.
FIG. 4 represents the work flow of the AMI core measure.
FIG. 5 represents the work flow of the HF core measure.
FIG. 6 represents the work flow of the pneumonia core measure.
FIG. 7 represents the work flow of the H&K core measure.
FIG. 8 represents the work flow of the SCIP core measure.
FIG. 9 represents the work flow of the Pregnancy (PR) core measure
FIG. 10 represents the work flow of the CABG core measure
FIG. 11 represents the work flow of the VTE core measure.

### Application Code

The application may be implemented as an Object Oriented software system using a third generation programming language, such as Java. This section both details the embodiment of one of the core components of the software system and details the application layout from a presentation perspective. The first section presents the contents of what is the equivalent of a technical specification for the Workflow engine. The second section presents screens mockups and example application flow to mimic what a user's interaction with the system would resemble.

Workflow Engine

The WorkFlowManager models the context of the workflow. Once initiated the Workflow Manager becomes the hub of activity for controlling navigation within the application. Information may be transmitted through the ViewController once a user submits their responses. The Workflow Manager may receive the relayed information, check the current state, determine available transitions, investigate the relayed information, determine the next transition within the Flow, and pass the mapping label of the next view back to the ViewController.

WorkFlowManager Class Declaration

The com.pts.core.workflow.WorkFlowManager class is responsible for controlling the management of application Flow objects. The WorkFlowManager functions as the state context and keeps a reference to the current state of the user-application instances. The WorkFlowManager may also be responsible for directing the building of state objects, transition objects and transition rule objects that may be available within the client session flow. The available states, transitions and transition rules may be configurable through a XML based file. The WorkFlowManager may utilize parsing technology supplied within the open source Apache Digester library to parse the XML file and instantiate the necessary work-flow objects.
Methods available on the WorkFlowManager class may be:

private WorkFlowManager( )

The private constructor for the class prevents outside classes from creating multiple instances of the class. Making the WorkFlowManager a Singleton class may insure that each running application instance only creates one WorkFlowManager. Within the overall architectural design of the application only one WorkFlowManager should be created for each instance of the application.

public static void init( )

The init method is used to initialize the WorkFlowManager. This method creates the singleton instance, performs other initial configurations and digests the XML configuration file associated with the WorkFlowManager.

public static WorkFlowManager getInstance( )

The getInstance method returns the singleton instance of the WorkFlowManager. Other classes use this method to obtain a handle to the WorkFlowManager.

public Flow getClientFlow(ResponseSet input)

### The getClientFlow method is called by the client in order to receive the client specific Flow object.

private String process(Object input)

The process method handles the logic to actually determine the next mapping view in the flow that may be returned to the ViewController. The method can iteratively process the Transitions associated with the active state, delegating to processing objects applying the associated RuleSet and or Rules till the appropriate Transition is identified.

### State Interface Declaration

The com.pts.core.workflow.State interface contains the methods to be implemented by the State implementation.

Methods defined in the State interface may be:

public void setProperties(Set properties)

### State implementations may need to implement a method that will set the properties associated with a State object.

public Set getProperties( )

### State implementations may need to implement a method that will return the Set of properties associated with a State object.

public void setName(String name)

### State implementations may need to implement a simple setter method that sets the name attribute of a State object.

public String getName( )

### State implementations may need to implement a simple getter method that retrieves the name attribute set on a State object.

public void getTransitions(List transitions)

### State implementations may need to implement a method that will set the Transition objects available on a State object.

public List getTransitions( )

### State implementations may need to implement a method that allows for the retrieval of a List of Transition objects available on a State object.

### BasicStateImpl Class Declaration

The com.pts.core.workflow.StateImpl class models a basic state object. The state represents a finite point in a path. The BasicStateImpl object is associated with one to multiple Transition objects, which allow for movement to another state.

### Transition Class Declaration

The com.pts.core.workflow.Transition class represents the link between two states within the overall system. Multiple Transition objects can be associated with a single State object, as the application flow lay have configurable branch points; branch points being explicit points within the workflow where state transitions may be determined by the answers to particular questions.

Methods available on the Transition class may be:

protected void addRule(Rule r)

### The method allows a Rule implementation to be added to a Transition object.

protected void addRuleSet(RuleSet rs)

### The method allows for a single RuleSet instance to be added to a Transition object.

public List getRules( )

### The method allows for the retrieval of the entire collection of Rule instances on a Transition object as a List.

public RuleSet getRuleSet( )

### The method used to retrieve the RuleSet, a grouping of Rule objects, on a Transition object.

protected setNextState(String state)

### Method used to set the end state for a Transition instance.

protected String getNextState( )

Method used to retrieve the name mapping for the end State of a Transition instance. Method would be called when the WorkFlowManager determines the transition applies.

### Rule Class Declaration

The Rule class is an abstract class with a factory method that allows for the instantiation of various rule implementations. This ultimately allows for new Rule implementations to be written and then plugged into the architecture by simply modifying the workflow XML configuration file.

Methods available on the Rule class may be:

public static getRuleInstance(Sting ruleImplName)

### The factory method that allows for the creation of Rule type objects based on the class name passed as an argument to the method.

public boolean checkRule(Object input)

### Abstract method to be implemented by all Rule implementations to allow for the WorkFlowManager to determine if a configured rule is met.

public List getRuleConditions( )

Abstract method to be implemented by all Rule implementations to allow for the retrieval of RuleCondition instances that may be part of a Rule instance.

### RuleSet Class Declaration

The RuleSet class may be a container for a set of Rule instances. When configuring a Transition a RuleSet can be associated with the object. All rules would need to be met within a RuleSet for the transition to be executed.

Methods available on the RuleSet class may be:

public RuleSet( )

### Default no arguments constructor used to create a RuleSet instance.

public void addRule(Rule r)

### The method used to add a Rule instance to a RuleSet.

public List getRules( )

### The method used to retrieve a collection as a List of all Rule instances within a RuleSet.

### RuleCondition Class Declaration

The RuleCondition class is an abstract class with a factory method that allows for the instantiation of various RuleCondition implementations. RuleConditions can be used as conditional evaluators on Rule implementations. This ultimately allows for new RuleCondition implementations to be written and then plugged into the architecture by simply modifying the workflow XML configuration file.

Methods available on the Rule class may be:

public static getRuleInstance(Sting ruleImplName)

### The factory method that allows for the creation of RuleCondition type objects based on the class name passed as an argument to the method.

public boolean checkRuleCondition(Object input)

Abstract method to be implemented by all RuleCondition implementations that allow for the determination of the condition. All conditions may be met for a Rule to apply.

### RuleCreationFactory Class Declaration

The RuleCreationFactory class extends the Apache Common digester class AbstractObjectCreationFactory. The RuleCreationFactory class may allow the Digester to create Rule objects based on rule elements within the XML configuration file.

### Implemented Method:

Public Object createObject(org.xml.sax.Attributes attributes)

### Factory method called by FactoryCreateRule to supply an object based on the element's attributes.

### RuleConditionCreationFactory Class Declaration

The RuleConditionCreationFactory class extends the Apache Common digester class AbstractObjectCreationFactory. The RuleConditionCreationFactory class may allow the Digester to create RuleCondition objects based on rule-condition elements within the XML configuration file.

### Implemented Method:

Public Object createObject(org.xml.sax.Attributtes attributes)

### Factory method called by FactoryCreateRule to supply an object based on the element's attributes.

### Example Flow:

An example segment of a flow configuration:

```
<?xml version=“1.0”?>
<flow>
  <!-- ********* Intro/discovery ********* -->
  <state name=“start” view-name=“intro1”>
    <transition name=“moveIntro2” next-state=“intro2”/>
  </state>
  <state name=“intro2” view-name=“intro2”>
    <transition name=“moveSymptom” next-state=“symptomSelect”/>
  </state>
  <state name=“symptomSelect” view-name=“sym1”>
    <transition name=“moveAmi” next-state=“ami-1”>
      <rule type=“com.pts.core.workflow.rules.GenericOrRule”>
        <rule-condition
            type=“com.pts.core.workflow.conditions.-
            StringMatchCondition”>
            <property name=“questionId” value=“symQ1”/>
            <property name=“value” value=“ami”/>
          </rule-condition>
        </rule>
    </transition>
    <transition name=“moveHF” next-state=“HF-1”>
        <rule type=“com.pts.core.workflow.rules.GenericOrRule”>
          <rule-condition
            type=“com.pts.core.workflow.conditions.-
            StringMatchCondition”>
            <property name=“questionId” value=“symQ1”/>
            <property name=“value” value=“hf”/>
          </rule-condition>
        </rule>
    </transition>
    <transition name=“movePneumonia” next-state=“pn-1”>
        <rule type=“com.pts.workflow.workflow.rules.GenericOrRule”>
          <rule-condition
            type=“com.pts.core.workflow.conditions.-
            StringMatchCondition”>
            <property name=“questionId” value=“symQ1”/>
            <property name=“value” value=“pneumonia”/>
          </rule-condition>
      </rule>
    </transition>
    <transition name=“movePregnancy” next-state=“p-1”>
      <rule type=“com.pts.core.workflow.rules.GenericOrRule”>
          <rule-condition
            type=“com.pts.core.workflow.conditions.-
            StringMatchCondition”>
            <property name=“questionId” value=“symQ1”/>
            <property name=“value” value=“pregnancy”/>
          </rule-condition>
      </rule>
    </transition>
    <transition name=“moveVTE” next-state=“vte-1”>
      <rule type=“com.pts.workflow.rules.GenericOrRule”>
        <rule- condition
          type=“com.pts core.workflow.conditions.-
          StringMatchCondition”>
            <property name=“questionId” value=“symQ1”/>
            <property name=“value” value=“vte”/>
        </rule-condition>
      </rule>
    </transition>
    <transition name=“moveHK” next-state=“hk-1”>
      <rule type=“com.pts.workflow.rules.GenericOrRule”>
        <rule-condition
            type=“com.pts.core.workflow.conditions.-
            StrinqMatchCondition”>
            <property name=“questionId” value=“symQ1”/>
            <property narne=“value” value=“hip_knee”/>
        </rule-condition>
      </rule>
    </transition>
    <transition name=“moveSCIP” next-state=“scip-1”>
      <rule type=“com.pts.workflow.rules.GenericOrRule”>
        <rule-condition
            type=“com.pts.core.workflow.conditions.-
            StringMatchCondition”>
            <property name=“questionId” value=“symQ1”/>
        <property name=“value” value=“scip”/>
      </rule-condition>
    </rule>
    </transition>
    <transition name=“moveCABG” next-state=“cabg-1”>
      <rule type=“com.pts.workflow.rules.GenericOrRule”>
          <rule-condition
            type=“com.pts.core.workflow.conditions.-
            StringMatchCondition”>
            <property name=“questionId” value=“symQ1”/>
            <property name=“value” value=“cabg”/>
          </rule-condition>
        </rule>
      </transition>
  </ state>
  <!-- ********* End of Intro Nodule ************* -->
</flow>
```

The above flow represents, essentially, the startup module of the application where a user would select the core measure (symptom) for which they would like to file a quality report. The user is presented the disease pathways in the sym1 view. The user would select the pathway to report against and then be directed along based on the answer context submitted by the presentation layer. The workflow would determine the corresponding start up state for the pathway.

### Example Application Flow

As indicated above, FIG. 2 depicts a flow of information in one embodiment of the invention. The following details a logical flow through the application highlighting key interactions of an end user with the presentation layer:

Application Login: User is presented a login screen when attempting to access the application. User may be required to enter username and password in order to authenticate against an enterprise user repository. FIG. 11 shows a login screen mockup.

Patient Identification: After authentication, the user would then identify the patient subject either through a patient search or via an existing patient encounter. FIG. 12 shows a lookup screen mockup.

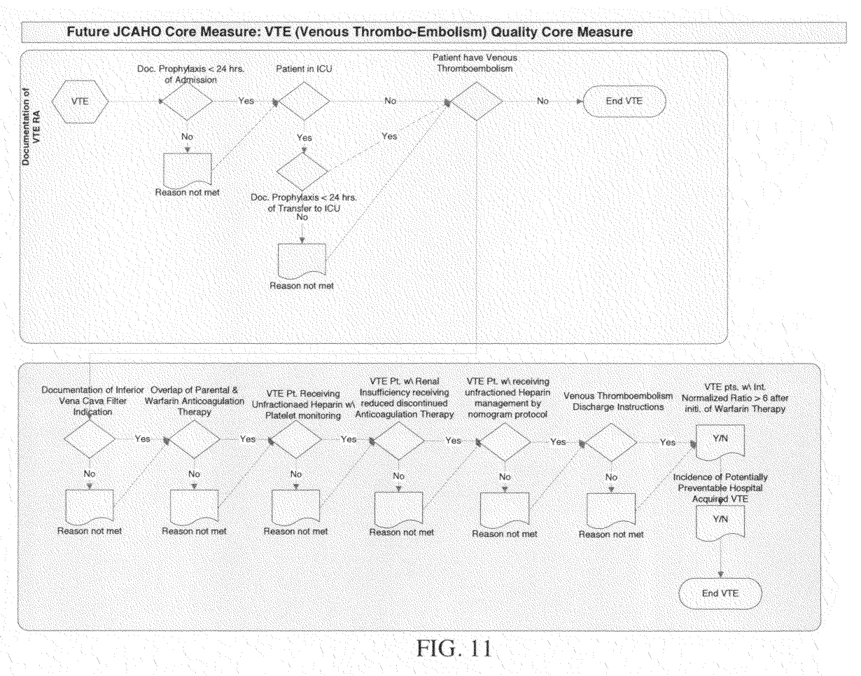

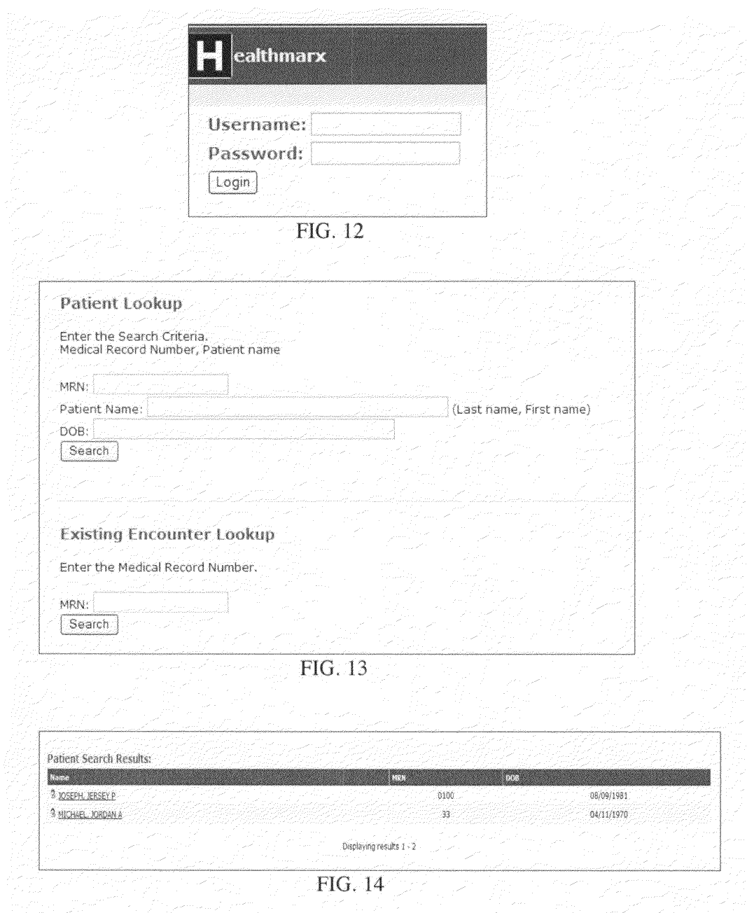

Patient Selection: If the patient is not uniquely identified based on the search criteria specified, the user may be presented a corresponding result selection screen. FIG. 13 shows a selection screen mockup.

Core Measure Selection: Once a patient is uniquely identified the user then selects the core measure for which they would like to enter quality data. FIG. 14 shows a pathway (Core Measure) selection screen mockup.

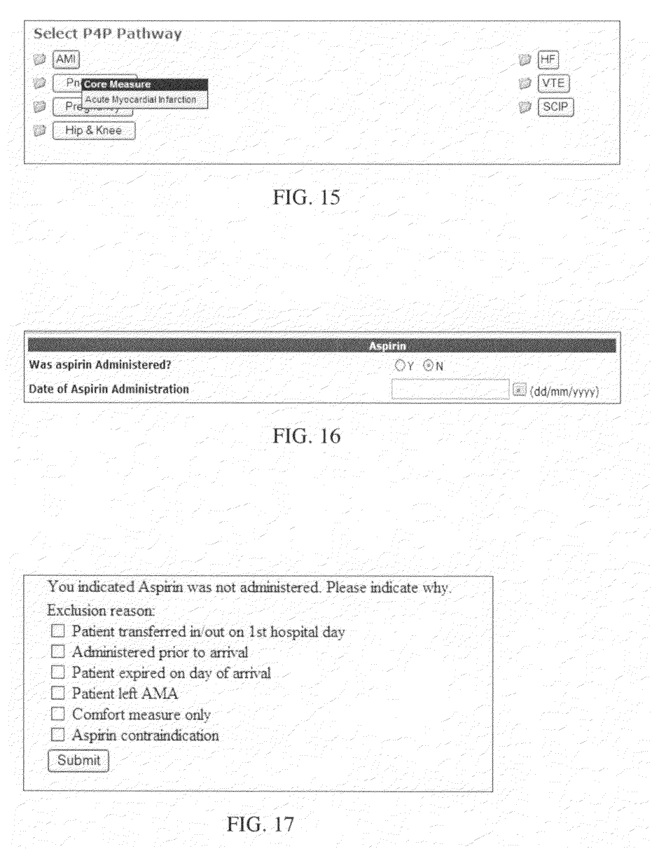

Core Measure Flow: Once the core measure indicator is selected and an encounter appropriately created or associated, the user is brought through a configured set of answer-context sensitive questions. FIG. 15 shows a coded screen AMI-1 mockup, “was aspirin administered?”

If the user indicates aspirin was not administered, then the workflow engine may determine that the next data screen should be AMI-1.1 (Aspirin Exclusion), as shown in FIG. 16, an answer-context sensitive data screen response mockup. If aspirin was administered screen AMI-1.1 would be skipped and the user would be presented screen AMI-6 (Beta-Blocker Administration). The user may then be navigated through all applicable questions and data screens for the core measure (refer to FIGS. 4-11) by the workflow manager.

### Core Measures

Each specific disease state which is presently under scrutiny by CMS or JCAHO includes specific core measures which are to be reported. These include performance or process measures as well as outcome measures. A typical performance measure would be “aspirin administration on arrival” for patients who present with myocardial infarction. Each hospital is required to determine whether each patient with myocardial infarction received aspirin on arrival in the emergency department, and report the percentage of patients achieving this core measure to CMS. A typical outcome measure would be mortality for myocardial infarction, which is reported to CMS as a percentage of myocardial infarction patients.

Mandatory CMS or JCAHO core measures for specific disease states include:

### JCAHO Core Measures

Acute Myocardial Infarction National Quality Core Measures
AMI-1 Aspirin at Arrival
AMI-2 Aspirin Prescribed at Discharge
AMI-3 ACEI or ARB for LVSD
AMI-4 Adult Smoking Cessation Advice/Counseling
AMI-5 Beta Blocker Prescribed at Discharge
AMI-6 Beta Blocker at Arrival
AMI-7 Median Time to Fibrinolysis
AMI-7a Fibrinolytic Therapy Received Within 30 Minutes of Hospital Arrival
AMI-8 Median Time to Primary PCI
AMI-8a Primary PCI Received Within 90 Minutes of Hospital Arrival
AMI-9** Inpatient Mortality
AMI-T1a* LDL Cholesterol Assessment (Optional Test Measure)
AMI-T2* Lipid Lowering Therapy at Discharge (Optional Test Measure)
*CMS ONLY **Joint Commission ONLY

Heart Failure National Quality Core Measures
HF-1 Discharge Instructions
HF-2 Evaluation of LVS Function
HF-3 ACEI or ARB for LVSD
HF-4 Adult Smoking Cessation Advice/Counseling

Pneumonia National Quality Core Measures
PN-1 Oxygenation Assessment
PN-2 Pneumococcal Vaccination
PN-3a Blood Cultures Performed Within 24 Hours Prior to or 24 Hours After Hospital Arrival for Patients Who Were Transferred or Admitted to the ICU Within 24 Hours of Hospital Arrival
PN-3b Blood Cultures Performed in the Emergency Department Prior to Initial Antibiotic Received in Hospital
PN-4 Adult Smoking Cessation Advice/Counseling
PN-5** Antibiotic Timing (Median)
PN-5a** Initial Antibiotic Received Within 8 Hours of Hospital Arrival
PN-5b Initial Antibiotic Received Within 4 Hours of Hospital Arrival
PN-6* Initial Antibiotic Selection for CAP in Immunocompetent Patient
PN-6a** Initial Antibiotic Selection for CAP in Immunocompetent—ICU Patient
PN-6b** Initial Antibiotic Selection for CAP Immunocompetent—Non ICU Patient
PN-7 Influenza Vaccination
*CMS only **Joint Commission only

Surgical Care Improvement Project National Quality Core Measures
SCIP-Inf-1a Prophylactic Antibiotic Received Within One Hour Prior to Surgical Incision—Overall Rate
SCIP-Inf-1b Prophylactic Antibiotic Received Within One Hour Prior to Surgical Incision—CABG
SCIP-Inf-1c Prophylactic Antibiotic Received Within One Hour Prior to Surgical Incision—Other Cardiac Surgery
SCIP-Inf-1d Prophylactic Antibiotic Received Within One Hour Prior to Surgical Incision—Hip Arthroplasty
SCIP-Inf-1e Prophylactic Antibiotic Received Within One Hour Prior to Surgical Incision—Knee Arthroplasty
SCIP-Inf-1f Prophylactic Antibiotic Received Within One Hour Prior to Surgical Incision—Colon Surgery
SCIP-Inf-1g Prophylactic Antibiotic Received Within One Hour Prior to Surgical Incision—Hysterectomy
SCIP-Inf-1h Prophylactic Antibiotic Received Within One Hour Prior to Surgical Incision—Vascular Surgery
SCIP-Inf-2a Prophylactic Antibiotic Selection for Surgical Patients—Overall Rate
SCIP-Inf-2b Prophylactic Antibiotic Selection for Surgical Patients—CABG
SCIP-Inf-2c Prophylactic Antibiotic Selection for Surgical Patients—Other Cardiac Surgery
SCIP-Inf-2d Prophylactic Antibiotic Selection for Surgical Patients—Hip Arthroplasty
SCIP-Inf-2e Prophylactic Antibiotic Selection for Surgical Patients—Knee Arthroplasty
SCIP-Inf-2f Prophylactic Antibiotic Selection for Surgical Patients—Colon Surgery
SCIP-Inf-2g Prophylactic Antibiotic Selection for Surgical Patients—Hysterectomy
SCIP-Inf-2h Prophylactic Antibiotic Selection for Surgical Patients—Vascular Surgery
SCIP-Inf-3a Prophylactic Antibiotics Discontinued Within 24 Hours After Surgery End Time—Overall Rate
SCIP-Inf-3b Prophylactic Antibiotics Discontinued Within 48 Hours After Surgery End Time—CABG
SCIP-Inf-3c Prophylactic Antibiotics Discontinued Within 48 Hours After Surgery End Time—Other Cardiac Surgery
SCIP-Inf-3d Prophylactic Antibiotics Discontinued Within 24 Hours After Surgery End Time—Hip Arthroplasty
SCIP-Inf-3e Prophylactic Antibiotics Discontinued Within 24 Hours After Surgery End Time—Knee Arthroplasty
SCIP-Inf-3f Prophylactic Antibiotics Discontinued Within 24 Hours After Surgery End Time—Colon Surgery
SCIP-Inf-3g Prophylactic Antibiotics Discontinued Within 24 Hours After Surgery End Time—Hysterectomy
SCIP-Inf-3h Prophylactic Antibiotics Discontinued Within 24 Hours After Surgery End Time—Vascular Surgery
SCIP-Inf-4 Cardiac Surgery Patients With Controlled 6 A.M. Postoperative Serum Glucose
SCIP-Inf-6 Surgery Patients with Appropriate Hair Removal
SCIP-Inf-7 Colorectal Surgery Patients with Immediate Postoperative Normothermia

Pregnancy And Related Conditions National Quality Core Measures
PR-1 VBAC
PR-2 Inpatient Neonatal Mortality
PR-3 Third or Fourth Degree Laceration

### CMS Core Measures

Acute Myocardial Infarction (AMI)
1. Aspirin at arrival
2. Aspirin prescribed at discharge
3. ACEI for LVSD
4. Smoking cessation advice/counseling
5. Beta blocker prescribed at discharge
6. Beta blocker at arrival
7. Thrombolytic received within 30 minutes of hospital arrival
8. PCI received within 120 minutes of hospital arrival
9. Inpatient mortality rate

Coronary Artery Bypass Graft (CABG)
1. Aspirin prescribed at discharge
2. CABG using internal mammary artery
3. Prophylactic antibiotic received within 1 hour prior to surgical incision
4. Prophylactic antibiotic selection for surgical patients
5. Prophylactic antibiotics discontinued within 24 hours after surgery end time
6. Inpatient mortality rate,
7. Post operative hemorrhage or hematoma
8. Post operative physiologic and metabolic derangement

Heart Failure (HF)
1. Left ventricular function (LVF) assessment
2. Detailed discharge instructions
3. ACEI for LVSD
4. Smoking cessation advice/counseling

Community Acquired Pneumonia (CAP)
1. Percentage of patients who received an oxygenation assessment within 24 hours prior to or after hospital arrival
2. Initial antibiotic consistent with current recommendations
3. Blood culture collected prior to first antibiotic administration
4. Influenza screening/vaccination
5. Pneumococcal screening/vaccination
6. Antibiotic timing, percentage of pneumonia patients who received first dose of antibiotics within four hours after hospital arrival
7. Smoking cessation advice/counseling

Hip And Knee Replacement (H&K)
1. Prophylactic antibiotic received within 1 hour prior to surgical incision
2. Prophylactic antibiotic selection for surgical patients
3. Prophylactic antibiotics discontinued within 24 hours after surgery end time
4. Post operative hemorrhage or hematoma
5. Post operative physiologic and metabolic derangement
6. Readmissions 30 days post discharge

Venous Thrombo-Embolism Quality Core Measures
1. Documentation of Venous Thromboembolism Risk Assessment (RA)/Prophylaxis within 24 Hours of Hospital Admission
2. Documentation of Venous Thromboembolism Risk Assessment (RA)/Prophylaxis within 24 Hours of Transfer to ICU
3. Documentation of Inferior Vena Cava Filter Indicatio
4. Venous Thromboembolism Patients with Overlap of Parenteral and Warfarin Anticoagulation Therapy
5. Venous Thromboembolism Patients Receiving Unfractionated Heparin with Platelet Count Monitoring
6. Venous Thromboembolism Patients with Renal Insufficiency that Received Reduced/Discontinued Anticoagulation Therapy
7. Venous Thromboembolism Patients Receiving Unfractionated Heparin Management by Nomogram/Protocol
8. Venous Thromboembolism Discharge Instructions
9. Venous Thromboembolism Patients with International Normalized Ratio >6 After Initiation of Warfarin Therapy
10. Incidence of Potentially Preventable Hospital-Acquired Venous Thromboembolism

### Core Measure Data Retrieval and Reporting:

These core measures are presently determined by manual chart review in patients who qualify for a given diagnosis based on their diagnosis CPT code. Even in medical centers that are equipped with electronic medical records, core measures are gleaned manually from doctor's orders, nurse's notes, OR or ER reports, radiology reports, or discharge summaries. The process of retrieving this data retrospectively is painstaking and expensive. Data entry into electronic systems for reporting core measures to CMS is also manually performed, or requires hospitals to contract with a third party vendor. As indicated above, FIG. 1 is a diagram showing an example of a P4P software environment which may be used in connection with one embodiment of the invention.

CMS collates the hospital performance on each and every core measure, and issues an overall rating of specific disease state care as above average, average, or below average. These ratings are then linked to pay for performance reimbursement schemes.

### Real-Time Core Measures Data Entry

The embodiment of the invention herein described provides a software program which allows the care-giver or hospital personnel to enter quality core measures performance data electronically, in real-time, at the patient bedside, while the processes of care are completed, and the care-giver in turn has the capacity to receive real-time feedback regarding compliance.

For instance, a patient presents to the hospital with myocardial infarction, aspirin and is administered in the ER and the date and time is recorded electronically by the ER doctor or ER nurse. They then receive real-time feedback indicating that they have not administered a beta-blocker and have not been compliant with the quality core measures. This prompting allows them to then take corrective action and administer a beta blocker as recommended. If a choice is made to not administer the beta blocker because the patient has bad chronic obstructive pulmonary disease which would prevent the use of the beta blocker, then this is entered so that the practitioner is not penalized for failing to administer a beta blocker. Further care in the cardiac catheterization laboratory or CCU can be entered by the cardiologist, catheterization laboratory tech, or CCU nurse, and discharge interventions can be entered at the time of discharge from the hospital by the discharging physician or nurse.

This real-time entry allows much more specific data to be gathered from the care giver than could be achieved retrospectively by chart review. In particular, the reasons for not administering a guidelines based therapy are recorded in real-time. Real-time data entry allows increased accuracy of the data entered, increased ability to document exclusions or contra-indications to specific therapies, and immediate feedback to the practitioner on his/her performance. In addition, real-time data entry may often improve care by ‘reminding” the care giver of the guideline therapies which the core measures quantify.

For instance, if a given core measure is not marked as completed, the person entering the data may receive visual reminders from the system that the core measure in question is not completed. Also, each core measure that is answered as “not completed” or “no” may result in a drop-down list of contra-indications to be presented to the user allowing the care giver to explain the reasons why the therapy was not given. This ensures better compliance with guideline therapy, and much more complete documentation of why certain therapies are not given so the caregiver is not penalized for failing to administer these drugs or therapies.

### Data Storage and Report Retrieval

Core measures data, entered in real time, are stored within the computer program and collated by patient name, encounter number and/or medical record number. The core measure data is also date and time stamped. All data is password protected, encrypted, and HPAA-compliant, to protect patient privacy. The data can be queried, and reports generated by patient, by diagnosis, by core measure, or by hospital. Reports can also be generated from the data by final CPT code, with collation, data review and subsequent electronic data transfer to JCAHO or CMS as part of their federally-mandated performance initiatives.

These steps essentially eliminate the need for manual retrospective chart review on the part of hospitals, decreasing costs, and increasing the accuracy of the data reported. In those cases where data cannot be entered at the bedside, it can be entered retrospectively by administrative personnel after manual chart review (as a fallback step only).

Finally, the program also allows the user to access medical reference materials on specific core measures. For instance, if a care giver has questions about the drug or therapy core measure which is being reported, he/she can access a list of standard medical references for each core measure from a drop-down list. This also enhances provider education and optimizes future core measure performance.

### Electronic Program Description

The software program can be either a stand-alone program, available for use and data entry at any computer terminal within a hospital, or it can be integrated into existing hospital electronic medical records systems. As indicated above, FIG. 1 is a diagram showing an example of a P4P software environment which may be used in connection with one embodiment of the invention.

Because the stand-alone program of the described embodiment is web-based, it can be accessed from any computer terminal or hand held device in a participating hospital, including in the ER, catheterization lab, OR, inpatient units, or quality assurance offices. The program can be accessed by selecting an icon on the screen, triggering the appearance of a sign-on function. After entering the patient name, medical record number, and an access code, the care giver is presented with a menu of diagnoses to fit the core measures reports illustrated above. After selecting a diagnosis, the care giver is guided through a menu of core measures, and prompted to enter appropriate responses to core measures queries.

Each core measure can be answered by a “yes” or “no” as to whether it was completed. Each “no” is followed by a drop-down menu of appropriate “contraindications” to a given core measure therapy. The care giver can choose to answer each core measure question, or leave them blank. Blank core measures questions are indicated as incomplete, as noted by a different color scheme. As the patient's care progresses, each core measure can be entered in turn, by any care giver or administrator, until all the core measures are reported. In addition, reference material describing the rationale for each core measure therapy can also be accessed by the care-giver from a drop down menu on the program, in case there are questions regarding eligibility, contra-indications, etc. This allows the program to be educational as well.

Integration of the stand-alone program into existing electronic systems also allows electronically-ordered or electronically-tracked core measures data to be incorporated automatically into the core measures database via a HL-7 interface. For instance, if a patient presents with a myocardial infarction, and aspirin is ordered through an electronic order-entry system in the ER, the program may automatically record that aspirin was given on arrival, meeting a myocardial infarction core measure. Similarly, discharge medications which are electronically recorded as part of electronic discharge instructions, can be automatically recorded in the core measures database. This allows data entry in real time, without involvement of staff.

Electronic Medical Record software companies which are HL-7 interface-compatible and with which integration is possible include:
Epic EpicCare Inpatient
McKesson Horizon Expert Orders and Doc.
Cerner Mill. PwrCht/PwrOrders/CareNet
Misys CPR
Eclipsys Sunrise Clinical Manager
Meditech C/S Enterprise Medical Record
GE LastWord Clinicals (IDX)
Siemens Soarian Clinical Access
CliniComp Essentris
GE Centricity Enterprise (Carecast)
QuadraMed Affinity

Emergency Medicine Electronic Medical Record Solutions with which are interface compatible and with which integration is possible include:
Wellsoft ICMS
MEDHOST EDMS
Allscripts/A4 HealthMatics ED
T-System T-SystemEV
McKesson Horizon Emergency Care
ECDS EmpowER
Picis ED PulseCheck (Ibex)
Meditech C/S EDM
Cerner Millennium FirstNet
CodoniX ED System
EDIMS EDIM
Emergisoft EmergisoftED

Cardiology Information Systems with which are interface compatible and with which integration is possible include:
Agfa
Emageon
GE
McKesson
Phillips
Siemens
WITT

The program can also be interfaced with laboratory and radiology information systems to input laboratory results, laboratory test data entry, cardiac catheterization lab data, Xray data, etc.

### Data Review and Editing

The program allows manual data entry as well as automatic data entry. Data can be entered in real time or retrospectively. It also allows the entry of CPT codes into the patient database by hospital or facility coders. The database can be queried by CPT code to produce hospital-specific, diagnosis-specific reports. These reports can be edited to determine which patients may be included in the reports that go to CMS or JCAHO before they are released.

The reports generated mirror the CMS and JCAHO core measures lists above. For each measure, the report may indicate the percentage of each core measure which was completed for the patients reported. If patient-specific core measures therapies are not given at the time of care, but contra-indications are marked in the core measures data, these core measures data are removed from the report denominator. In addition, outcome measures such as mortality may also be presented as a percentage of all patients reported. Finally, time-measures such as “door to balloon” time may be presented as a mean in minutes, as well as a percentage reaching the required target time internal.

For those patient outcome core measures which are risk adjusted (AMI mortality, SCIP mortality, etc) the risks of each core measure occurring are adjusted based on patient age, sex, and complicating ICD9 diagnoses. These risk adjustment indexes are calculated by CMS or JCAHO based on the data presented to them. Given that the program includes all clinical data entered at the bedside as well as ICD9 data entered by hospital coders after hospital discharge, all the risk adjustment data needed by CMS or JCAHO is present in the reports which are sent to them. No additional data entry is needed.

### Other Embodiments

The Software may be expanded to incorporate all guideline recommendations supporting the CMS/JCAHO core measures as well as to integrate P4P (pay for performance) initiatives whether designed by federal authoritative bodies or private payers. These guideline recommendations will have corresponding “tickler” boxes with associated links to specific journal articles referenced within the guidelines and to product information associated with the associated guideline recommended therapies.

Software updates may occur as the CMS/JCAHO core measures are modified and adapted to emerging clinical data and as P4P initiatives are implemented nationally. As such, the software program may be dynamic and evolutionary in order to capture these continual trends and changes regarding core measures, pay for performance initiatives and the clinical and/or financial data supporting these efforts.

Initially, the described embodiment of the software technology may be used for the hospital setting focused upon CMS/JCAHO core measures and related P4P initiatives, but future versions may be available for physician practice groups, outpatient care centers and specialty centers. Also, other updates to the software program may include the data capture and reporting to corresponding regulatory authorities of safety measures such as sentinel events, adverse drug events, and the attainment of national patient safety goals.

Not only may the software program be dynamic, adaptive and evolutionary, but the corresponding database may be as well. In future embodiments, patient outcomes may be entered at hospital discharge. This may allow for development of patient risk scores so that high risk patients can be identified on arrival. Thus, there is an iterative feedback loop relating patient outcomes at discharge to care processes that are initiated on patient arrival.

Using “fuzzy logic” or “neural networking”, caregivers could be provided real-time feedback regarding potential outcomes if a care process is or is not followed. For example, the program would provide real-time feedback stating “At your hospital, if you delay administering aspirin by 12 more hours, the odds of death may be increased by 25%”. Not only may processes of care, but also risk stratified patient outcomes may be compared to local and national benchmarks.

The database can be designed to link to other nationally respected databases centered upon quality improvement correlating to patient care, throughput, efficient process management and/or federal or private payer pay for performance initiatives. Examples of such databases could be the newly formed ACTION registry managed by NCDR/ACC, Premier Advisor Suite, the CMS SMG database, the STENT registry, ADHERE, Stroke Trials Registry with the American Heart Association or Solucient.

The embodiment of the invention described herein provides an electronic platform to collect clinical information and enhance patient records which will certify hospitals for additional 1-2% payments from CMS-Centers for Medicaid/Medicare services (hospital profit margins are 1-2%), improve guideline compliance via early/immediate feedback, provide local and national benchmarking and reduce medical errors.

The described software will provide instant, real time feedback on medical decisions, compliance with guidelines, will reduce medication errors and will ensure the hospital will maximize reimbursement. The software will also capture CMS/P4P performance measures, offer flexibility for continual updates, offset medical errors, report A/Es: Industry/FDA plus sentinel events and reinforce guideline recommendations.

Computerized core measures tracking electronically tracks use of meds, timing of meds, timing of interventions and discharge meds. Diagnosis is triggered by markers, LVEF, order sets, working diagnosis, chief complaint, Xray result (not retrospective ICD 9). This matches performance to diagnosis, with continuous real-time feedback of performance.

While the foregoing written description of the invention enables one of ordinary skill to make and use what is considered presently to be the best mode thereof those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

We claim:

1. A software based system for the data capture of selected CMS/JCAHO core measures, comprising:
a input device to receive input data corresponding to said selected measures;
a processor, including an electronic database to store and compare said selected measures:
a configurable report generator to generate reports corresponding to said selected measures stored and compared by said electronic database;
an external interface for electronic transmission of reports generated by said configurable report generator create standard output formats including text-delimited, pdf and html.

2. The system of claim 1 wherein the report module includes reports that can be used by a healthcare organization to report by patients, by patient panels, by diagnosis, by core measure, or by hospital, by diagnosis CPT codes.

3. The system of claim 1 and further including a core workflow manager to assure compliance with core measures, determined through a set of predetermined interactive question sets.

4. The system of claim 1 and further including a HL7 messaging processor for processing of standard HL7 messages for facilitation of core measure data reporting.

5. The system of claim 3 wherein said workflow manager includes a workflow engine which comprises a configurable state transition machine.

6. The system of claim 3 and further including a view controller which supplies information to said work flow manager.

7. The system of claim 1 wherein said electronic database receives input data from different sites and compares performance at said different sites.

8. The system of claim 1 wherein said database is dynamic and evolutionary in order to capture trends and changes regarding core measures, pay for performance initiatives and the clinical and/or financial data supporting these efforts

9. A method of filing CMS/JCAHO core measures for patients comprising the following steps:
searching for and identifying a patient of record via any combination of: unique medical record number, name, patient encounter identifier, digital identifier or demographic data items such as date of birth or gender;
selecting a disease pathway and
entering coded key data points for selected pathway.

10. The method of claim 9 and further including presenting to a user questions and answers which are context sensitive according to configured flows within a workflow manager.

11. The method of claim 9 and further including editing and error correcting previously entered data items.

12. The method of claim 9 and further including indicating record completion and releasing a patient record.

13. The method of claim 9 and further including, assuring compliance with core measures, in accordance with said questions and answers which are context sensitive.

14. The method of claim 10 wherein said presenting to a user questions and answers comprises modeling states and transitions as decision points and links, such that a decision is made, and a link is followed (a transition is made) to arrive at another state (decision point).

15. The method of claim 14 and further including modifying the states and transitions via configuration changes and without any changes in source code to represent the changes in question sets.

16. A software based method for the data capture of selected CMS/JCAHO core measures, comprising:
receiving input data corresponding to said selected measures;
storing and comparing said selected measures
generating reports corresponding to said selected measures which have been stored and compared;
electronically transmitting reports in standard output formats including text-delimited, pdf and html.

17. The method of claim 16 wherein said generating includes generating canned reports that can be used by a healthcare organization to report by patients, by patient panels, by diagnosis, by core measure, or by hospital, by diagnosis CPT codes.

18. The method of claim 16 and further including determining compliance with core measures, through a set of predetermined interactive question sets.

19. The method of claim 16 and further including processing of standard HL7 messages for facilitation of core measure data reporting.

20. The method of claim 16 wherein said receiving and said comparing include receiving input data from different sites and comparing performance at said different sites.

21. The method of claim 16 and further including presenting to a user questions and answers which are context sensitive according to configured flows within a workflow manager.

22. The method of claim 21 wherein said presenting to a user questions and answers comprises modeling states and transitions of a configurable state transition machine as decision points and links, such that a decision is made, and a link is followed (a transition is made) to arrive at another state (decision point).

23. The method of claim 22 and further including modifying the states and transitions via configuration changes and without any changes in source code to represent the changes in question sets.

24. The method of claim 16 and further including incorporating guideline recommendations supporting the CMS/JCAHO core measures, and integrating P4P initiatives designed by federal authoritative bodies and private payers.

25. The method of claim 24 and further including providing links to journal articles referenced within the guideline recommendations and to product information associated with guideline recommended therapies.

26. The method of claim 16 and further including updating as the CMS/JCAHO core measures are modified and adapted to emerging clinical data and as P4P initiatives are implemented nationally.

27. The method of claim 16 and further including providing dynamic and evolutionary software in order to capture trends and changes regarding core measures, pay for performance initiatives and the clinical and/or financial data supporting these efforts.

28. The method of claim 16 and further including reporting to corresponding regulatory authorities of safety measures such as sentinel events, adverse drug events, and the attainment of national patient safety goals.

29. The method of claim 16 and further including applying patient risk scores so that high risk patients can be identified, and an iterative feedback loop relating patient outcomes at discharge to care processes that are initiated on patient arrival.

30. The method of claim 16 and further including using fuzzy logic or neural networking for providing caregivers real-time feedback regarding potential outcomes if a care process is or is not followed.

31. The method of claim 16 and further including comparing risk stratified patient outcomes to local and national benchmarks.

32. The method of claim 16 and further including linking to other databases centered correlating to patient care, throughput, efficient process management, and/or federal or private payer pay for performance initiatives.

33. The method of claim 16 and further including tracking electronically use of meds, timing of meds, timing of interventions and discharge meds.

34. The method of claim 16 and further including triggering diagnosis by markers, including at least one of LVEF, order sets, working diagnosis, chief complaint and Xray result.

35. The method of claim 16 and further including matching performance to diagnosis, with continuous real-time feedback of performance.
